(19) United States
(12) Patent Application Publication
(10) Pub. No.: US 2017/0212374 A1
(43) Pub. Date: Jul. 27, 2017

(54) LIQUID CRYSTAL DEVICES AND THE LIQUID CRYSTAL PANELS THEREOF

(71) Applicant: Wuhan China Star Optoelectronics Technology Co., Ltd., Wuhan (CN)

(72) Inventor: Qiang GONG, Shenzhen (CN)

(73) Assignee: Wuhan China Star Optoelectronics Technology Co., Ltd., Wuhan (CN)

(21) Appl. No.: 15/186,412

(22) Filed: Jun. 17, 2016

(30) Foreign Application Priority Data
Jan. 25, 2016 (CN) 2016100494227

(51) Int. Cl. G02F 1/1368; G02F 1/1362

(52) U.S. Cl. CPC G02F 1/1368; G02F 1/136286; G02F 2201/121

(57) ABSTRACT

A liquid crystal panel includes a substrate, a number of scanning lines, a number of data lines, a first switch unit, and a second switch unit. During the normal operations of the liquid crystal panel, the first switch unit and the second switch unit are disconnected. When the power supply of the liquid crystal panel is abnormally interrupted, the first switch unit and the second switch unit are connected, the scanning lines connect to the common electrode, and the data lines connect to the common electrode such that the voltage of the scanning lines is the same with the voltage of the common electrode, and the voltage of the data lines is the same with the voltage of the common electrode. Further, the voltage of the pixel electrode is the same with the voltage of the common electrode.

### BACKGROUND OF THE INVENTION

1. Field of the Invention

The present disclosure relates to liquid crystal display technology, and more particularly to a liquid crystal display (LCD) and the liquid crystal panel thereof.

2. Discussion of the Related Art

During normal operations of LCDs, the pixel electrode and the common electrode apply a voltage toward the liquid crystals of the LCD. The display brightness of the LCD is adjusted by configuring the voltage.

When the voltage applied to both ends of the liquid crystals remain the same, direct current (DC) residue may cause abnormal display of the LCDs. Thus, conventionally, a black image is inserted before the LCD is turned off. That is, the DC residue is avoided by configuring the pixel electrode and the common electrode to be the same.

Nevertheless, when the LCD is abnormally powered off, such as the power supply is drew out or the instant power failure, the black image cannot be inserted. Thus, the voltage applied to two ends of the liquid crystals may remain, which causes the DC residue.

### SUMMARY

The present disclosure relates to a LCD and the liquid crystal panel to overcome the above-mentioned problem.

In one aspect, a liquid crystal panel includes: a substrate; a plurality of scanning lines arranged on the substrate; a plurality of data lines arranged on the substrate, the data lines intersect with the scanning lines; a first switch unit, each of the scanning lines connects to a common electrode via the first switch unit; a second switch unit, each of the data lines connects to a common electrode via the second switch unit; and wherein during normal operations of the liquid crystal panel, the first switch unit and the second switch unit are disconnected, and when the power supply of the liquid crystal panel is abnormally interrupted, the first switch unit and the second switch unit are connected, the scanning lines connect to the common electrode, and the data lines connect to the common electrode.

Wherein the liquid crystal panel further includes: a plurality of pixel cells formed by intersecting the scanning lines and the data lines; a first thin film transistor (TFT), a first end of the first TFT (T1) connects to the scanning lines, a second end of the first TFT (T1) connects to the data lines, and a third end of the first TFT (T1) connects to the pixel cell.

Wherein the first switch unit includes a second TFT (T2), a first end of the second TFT (T2) connects with one end of the scanning line, a second end of the second TFT (T2) connects to a first reference signals (VGL), and a third end of the second TFT (T2) connects to the common electrode (COM).

Wherein during the normal operations of the liquid crystal panel, the first reference signals (VGL) controls the second TFT (T2) to be disconnected, and the scanning lines and the common electrode (COM) are disconnected, when the power supply of the liquid crystal panel is abnormally interrupted, the first reference signals (VGL) controls the second TFT (T2) to be connected, and the scanning lines connect to the common electrode (COM) via the second TFT.

Wherein the first switch unit further includes a third TFT (T3), a first end of the third TFT (T3) connects to the other end of the scanning lines, a second end of the third TFT (T3) connects to the first reference signals (VGL), and a third end of the third TFT (T3) connects to the common electrode (COM).

Wherein during the normal operations of the liquid crystal panel, the first reference signals (VGL) controls the second TFT (T2) and the third TFT (T3) to be disconnected, and the scanning lines and the common electrode (COM) are disconnected, when the power supply of the liquid crystal panel is abnormally interrupted, the first reference signals (VGL) controls the second TFT (T2) and the third TFT (T3) to be connected, and the scanning lines connects to the common electrode (COM) via the second TFT (T2) and the third TFT (T3).

Wherein the second switch unit includes the fourth TFT (T4) and the fifth TFT (T5), a first end of the fourth TFT (T4) connects to a first end of the fifth TFT (T5) and one end of the data line, a second end of the fourth TFT (T4) connects to second reference signals (VGH), a third end of the fourth TFT (T4) and a third end of the fifth TFT (T5) connects to the common electrode (COM), and a second end of the fifth TFT (T5) connects to the first reference signals (VGL).

Wherein during the normal operations of the liquid crystal panel, the first reference signals (VGL) controls the fifth TFT (T5) to be disconnected, the second reference signals (VGH) controls the fourth TFT (T4) to be disconnected, and the data line and the common electrode (COM) are disconnected, when the power supply of the liquid crystal panel is abnormally interrupted, the first reference signals (VGL) controls the fifth TFT (T5) to be connected, and the data lines connect to the common electrode (COM) via the fifth TFT (T5).

Wherein the first TFT (T1) and the fourth TFT (T4) are P-type TFTs, and the second TFT (T2), the third TFT (T3), and the fifth TFT (T5) are N-type TFTs.

In one aspect, a liquid crystal device (LCD) includes any one of the above liquid crystal panel.

In view of the above, the liquid crystal panel includes a substrate, a plurality of scanning lines, a plurality of data lines, a first switch unit, and a second switch unit. During the normal operations of the liquid crystal panel, the first switch unit and the second switch unit are disconnected. When the power supply of the liquid crystal panel is abnormally interrupted, the first switch unit and the second switch unit are connected, the scanning lines connect to the common electrode, and the data lines connect to the common electrode such that the voltage of the scanning lines is the same with the voltage of the common electrode, and the voltage of the data lines is the same with the voltage of the common electrode. Further, the voltage of the pixel electrode is the same with the voltage of the common electrode. In this way, the DC voltage at two ends of the liquid crystals may be eliminated so as to avoid the DC residue.

### BRIEF DESCRIPTION OF THE DRAWINGS

FIG. 1 is a circuit diagram of the liquid crystal panel in accordance with one embodiment.

FIG. 2 is a schematic view of the liquid crystal panel of FIG. 1.

FIG. 3 is a simulation diagram of the liquid crystal panel of FIG. 1 showing the negative charges are released when the liquid crystal panel is abnormally power offed.

FIG. 4 is a simulation diagram of the liquid crystal panel of FIG. 1 showing the positive charges are released when the liquid crystal panel is abnormally powered off.

FIG. 5 is a schematic view of the LCD in accordance with one embodiment.

### DETAILED DESCRIPTION OF THE EMBODIMENTS

Embodiments of the invention will now be described more fully hereinafter with reference to the accompanying drawings, in which embodiments of the invention are shown.

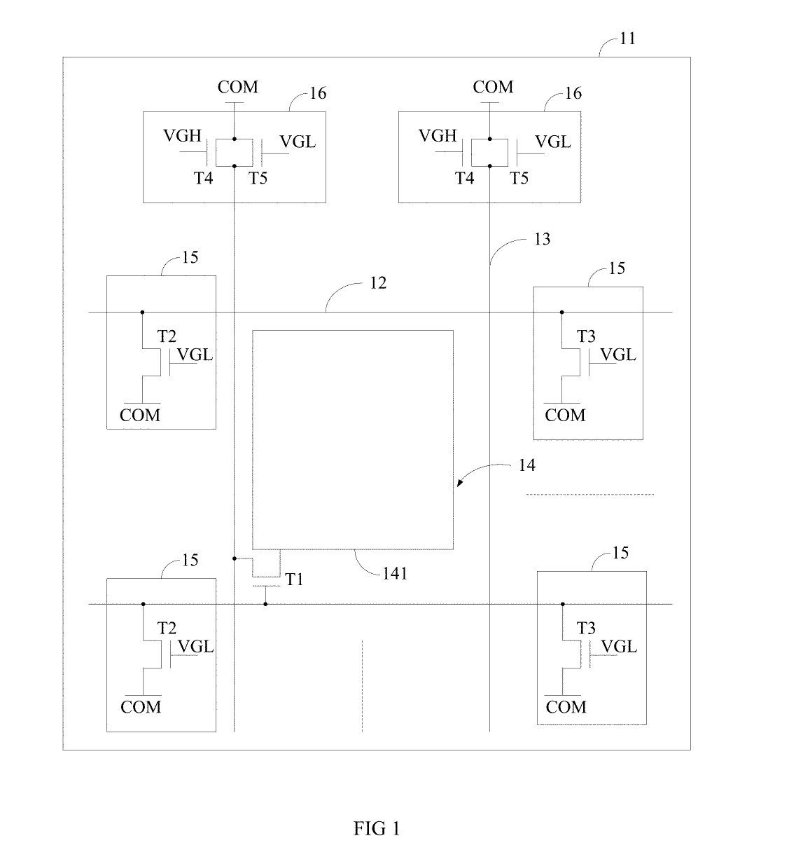

FIG. 1 is a circuit diagram of the liquid crystal panel in accordance with one embodiment. The liquid crystal panel may be incorporated in the LCD, such as phones and notebooks. As shown in FIG. 1, the liquid crystal panel includes a substrate 11, a plurality of scanning lines 12, a plurality of data lines 13, a plurality of pixel cells 14, a first thin film transistor (TFT) (T1), a first switch unit 15, a second switch unit 16, and a common electrode (COM).

In the embodiment, the scanning lines 12 and the data lines 13 are arranged on the substrate 11, and the scanning lines 12 and the data lines 13 intersect with each other to form a plurality of pixel cells 14.

Each of the pixel cells 14 includes a pixel electrode 141. A drain of the first TFT (T1) connects to the pixel electrode 141. A source of the first TFT (T1) connects to the data line 13. A gate of the first TFT (T1) connects to the scanning line 12. During the normal operations of the liquid crystal panel, the scanning lines 12 provide scanning signals to the first TFT (T1) to turn on the first TFT (T1). The first TFT (T1) transmits the data signals of the data lines 13 to the pixel electrode 141, that is, the voltage is applied to the pixel electrode 141.

Each of the scanning lines 12 connects to the common electrode (COM) via the first switch unit 15. Each of the data lines 13 connects to the common electrode (COM) via the second switch unit 16. During the normal operations of the liquid crystal panel, the first switch unit 15 and the second switch unit 16 are disconnected. At this moment, the scanning lines 12 is disconnected with the common electrode (COM), the data lines 13 is disconnected with the common electrode (COM), and the voltage of the pixel electrode 141 is the same with the voltage of the data lines 13. Thus, first switch unit 15 and the second switch unit 16 may not affect the normal display of the liquid crystal panel.

Preferably, the scanning lines 12 connect to a scanning-line driving chip (not shown), and the scanning-line driving chip provides the scanning signals to the scanning lines 12. The data lines 13 connects to the data-line driving chip (not shown), and the data-line driving chip provides the data signals to the data lines 13.

Before the power supply of the liquid crystal panel is abnormally interrupted, the first switch unit 15 and the second switch unit 16 are turned on. At this moment, the scanning lines 12 and the common electrode (COM) are connected, and the voltage of the scanning lines 12 and the voltage of the common electrode (COM) are the same. The data lines 13 and the common electrode (COM) are connected, and the voltage of the data lines 13 are the same with the voltage of the common electrode (COM). The voltage of the pixel electrode 141 is leaked via the first TFT (T1) so as to be the same with the common electrode (COM).

FIG. 2 is a schematic view of the liquid crystal panel of FIG. 1. As shown in FIG. 2, the liquid crystal panel includes a top substrate 17, a liquid crystal layer 18, and a common electrode (COM) on the top substrate 17. The top substrate 17 and the substrate 11 are spaced apart from each other. The liquid crystal layer 18 is arranged between the top substrate 17 and the substrate 11. Specifically, the liquid crystal layer 18 is arranged between the pixel electrode 141 and the common electrode (COM).

During the normal operations of the liquid crystal panel, the voltage of the pixel electrode 141 is the same with the voltage of the data lines 13, and a voltage difference between the pixel electrode 141 and the common electrode (COM) is generated, such that the liquid crystals within the liquid crystal layer 18 deviate.

When the power supply of the liquid crystal panel is abnormally interrupted, the voltage of the pixel electrode 141 is leaked via the first TFT (T1) so as to be the same with the voltage of the common electrode (COM), which eliminates the DC voltage at two ends of the liquid crystals within the liquid crystal layer 18. In this way, the DC residue is avoided.

Preferably, the first switch unit 15 includes a second TFT (T2). A first end of the second TFT (T2) connects with one end of the scanning line 12, a second end of the second TFT (T2) connects to a first reference signals (VGL), and a third end of the second TFT (T2) connects to the common electrode (COM).

During the normal operations of the liquid crystal panel, the first reference signals (VGL) controls the second TFT (T2) to be disconnected, and the scanning lines 12 and the common electrode (COM) are disconnected. When the power supply of the liquid crystal panel is abnormally interrupted, the first reference signals (VGL) controls the second TFT (T2) to be connected, and the scanning lines 12 connect to the common electrode (COM) via the second TFT (T2).

In one embodiment, the first switch unit 15 further includes a third TFT (T3), a first end of the third TFT (T3) connects to the other end of the scanning lines 12, a second end of the third TFT (T3) connects to the first reference signals (VGL), and a third end of the third TFT (T3) connects to the common electrode (COM).

During the normal operations of the liquid crystal panel, the first reference signals (VGL) controls the second TFT (T2) and the third TFT (T3) to be disconnected, and the scanning lines 12 and the common electrode (COM) are disconnected. When the power supply of the liquid crystal panel is abnormally interrupted, the first reference signals (VGL) controls the second TFT (T2) and the third TFT (T3) to be connected, and the scanning lines 12 connects to the common electrode (COM) via the second TFT (T2) and the third TFT (T3) so as to quickly pull the voltage of the scanning lines 12 until the voltage of the scanning lines 12 is the same with the voltage of the common electrode (COM).

In one embodiment, the second switch unit 16 includes the fourth TFT (T4) and the fifth TFT (T5). A first end of the fourth TFT (T4) connects to a first end of the fifth TFT (T5) and one end of the data line 13, a second end of the fourth TFT (T4) connects to second reference signals (VGH), a third end of the fourth TFT (T4) and a third end of the fifth TFT (T5) connects to the common electrode (COM), and a second end of the fifth TFT (T5) connects to the first reference signals (VGL).

During the normal operations of the liquid crystal panel, the first reference signals (VGL) controls the fifth TFT (T5) to be disconnected, the second reference signals (VGH) controls the fourth TFT (T4) to be disconnected, and the data line 13 and the common electrode (COM) are disconnected. When the power supply of the liquid crystal panel is abnormally interrupted, the first reference signals (VGL) controls the fifth TFT (T5) to be connected, and the data lines 13 connect to the common electrode (COM) via the fifth TFT (T5); and/or the second reference signals (VGH) controls the fourth TFT (T4) to be connected, and the data lines 13 connects to the common electrode (COM) via the fourth TFT (T4).

In one embodiment, the liquid crystal panel further includes the scanning-line driving chip (not shown) connecting with the scanning lines 12 and the data-line driving chip (not shown) connecting with the data lines 13, wherein the scanning-line driving chip is configured for providing the scanning signals to the scanning lines 12, and the data-line driving chip is configured for providing the data signals to the data lines 13. The first reference signals (VGL) and the second reference signals (VGH) are provided by the scanning-line driving chip and/or data-line driving chip. In other embodiments, the first reference signals (VGL) and the second reference signals (VGH) may be provided by other control chips.

In one embodiment, the first TFT (T1) and the fourth TFT (T4) are P-type TFTs, and the second TFT (T2), the third TFT (T3), and the fifth TFT (T5) are N-type TFTs.

During the normal operations of the liquid crystal panel, the first reference signals (VGL) are at the high level, and the second TFT (T2), the third TFT (T3), and the fifth TFT (T5) are disconnected. The second reference signals (VGH) are at the low level, and the fourth TFT (T4) is disconnected. At this moment, the scanning lines 12 and the data lines 13 are disconnected with the common electrode (COM).

When the power supply of the liquid crystal panel is abnormally interrupted, the first reference signals (VGL) are at the low level, and the second TFT (T2), the third TFT (T3), and the fifth TFT (T5) are connected. The second reference signals (VGH) are at the high level, and the fourth TFT (T4) is connected. At this moment, the scanning lines 12 and the data lines 13 are connected with the common electrode (COM) such that the DC voltage at two ends of the liquid crystals within the liquid crystal layer 18 is eliminated so as to avoid the DC residue.

In other embodiments, the first TFT (T1) and the fourth TFT (T4) are N-type TFTs, and the second TFT (T2), the third TFT (T3), and the fifth TFT (T5) are P-type TFTs.

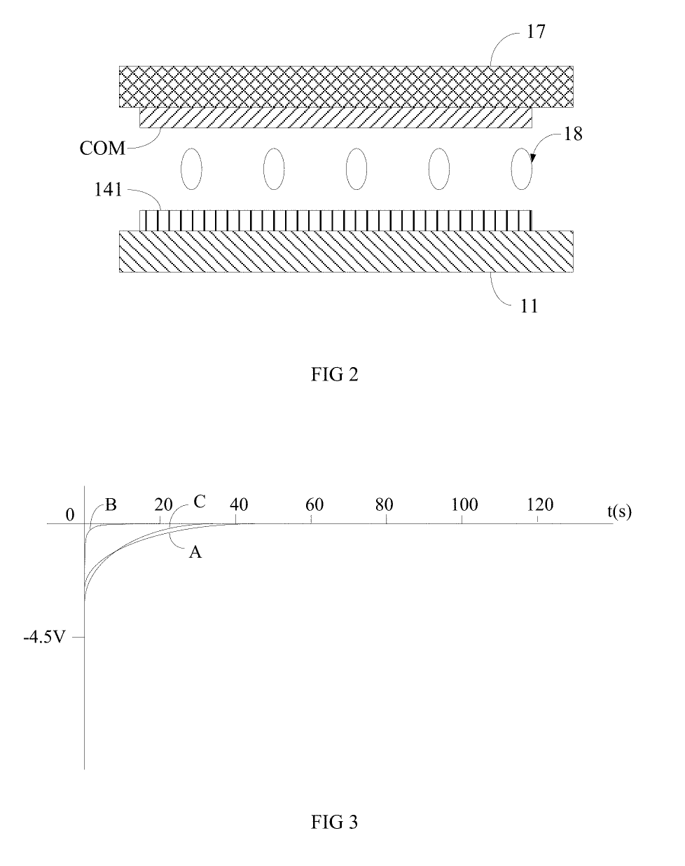

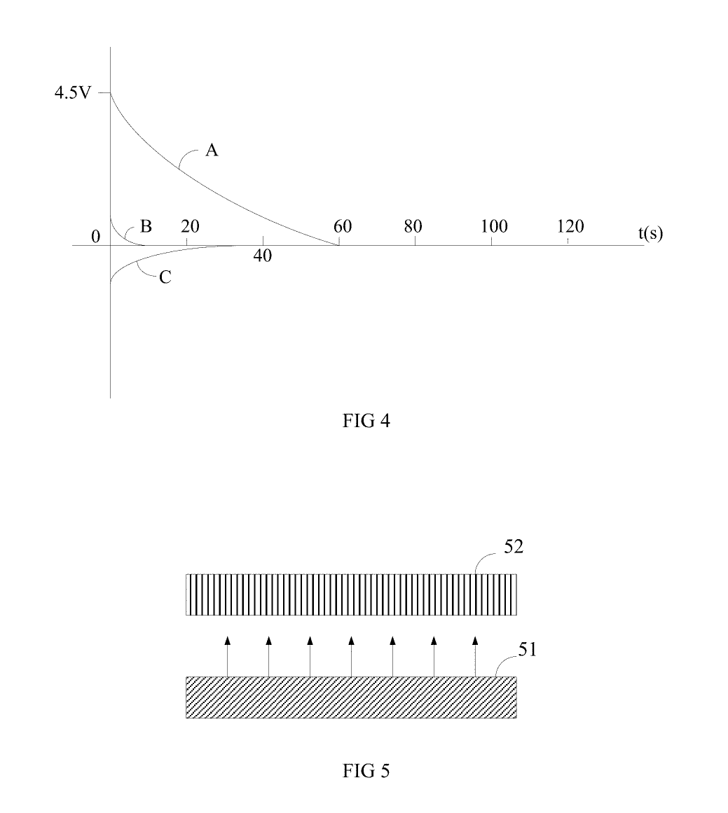

FIG. 3 is a simulation diagram of the liquid crystal panel of FIG. 1 showing the negative charges are released when the liquid crystal panel is abnormally powered off. FIG. 4 is a simulation diagram of the liquid crystal panel of FIG. 1 showing the positive charges are released when the liquid crystal panel is abnormally power offed. As shown in FIGS. 3 and 4, the curve (A) is the curve showing the released residue charges when the power supply of the pixel electrode 141 is abnormally interrupted, the curve (B) is the curve showing the released residue charges when the power supply of the data line 13 is abnormally interrupted, and the curve (C) is the curve showing the released residue charges when the power supply of the scanning line 12 is abnormally interrupted,

When the power supply of the liquid crystal panel is abnormally interrupted, the data lines 13 connects to the common electrode (COM) via the fourth TFT (T4), and the fourth TFT (T4) is the P-type TFT so as to enhance the releasing speed of the residue charges when the power supply of the data line 13 is abnormally interrupted, which enhances the releasing speed of the residue charges of the pixel electrode 141. As shown in FIG. 3, the initial voltage of the pixel electrode 141 is −4.5V, and it takes 40 seconds to release the residue negative charges by the pixel electrode 141. As shown in FIG. 4, the initial voltage of the pixel electrode 141 is 4.5V, and it takes 60 seconds to release the residue negative charges by the pixel electrode 141.

FIG. 5 is a schematic view of the LCD in accordance with one embodiment. The LCD includes a backlight module 51 and a liquid crystal panel 52 arranged on a light-emitting surface of the backlight module 51. The backlight module 51 is configured for providing a light source to the liquid crystal panel 52, and the liquid crystal panel 52 may be the liquid crystal panel in any one of the above embodiments.

In view of the above, the liquid crystal panel includes a substrate, a plurality of scanning lines, a plurality of data lines, a first switch unit, and a second switch unit. During the normal operations of the liquid crystal panel, the first switch unit and the second switch unit are disconnected. When the power supply of the liquid crystal panel is abnormally interrupted, the first switch unit and the second switch unit are connected, the scanning lines connect to the common electrode, and the data lines connect to the common electrode such that the voltage of the scanning lines is the same with the voltage of the common electrode, and the voltage of the data lines is the same with the voltage of the common electrode. Further, the voltage of the pixel electrode is the same with the voltage of the common electrode. In this way, the DC voltage at two ends of the liquid crystals may be eliminated so as to avoid the DC residue.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a substrate;
a plurality of scanning lines arranged on the substrate;
a plurality of data lines arranged on the substrate, the data lines intersect with the scanning lines;
a first switch unit, each of the scanning lines connects to a common electrode via the first switch unit;
a second switch unit, each of the data lines connects to a common electrode via the second switch unit; and
wherein during normal operations of the liquid crystal panel, the first switch unit and the second switch unit are disconnected, and when the power supply of the liquid crystal panel is abnormally interrupted, the first switch unit and the second switch unit are connected, the scanning lines connect to the common electrode, and the data lines connect to the common electrode.

2. The liquid crystal panel claimed in claim 1, wherein the liquid crystal panel further comprises:
a plurality of pixel cells formed by intersecting the scanning lines and the data lines;
a first thin film transistor (TFT), a first end of the first TFT (T1) connects to the scanning lines, a second end of the first TFT (T1)connects to the data lines, and a third end of the first TFT (T1) connects to the pixel cell.

3. The liquid crystal panel claimed in claim 2, wherein the first switch unit comprises a second TFT (T2), a first end of the second TFT (T2) connects with one end of the scanning line, a second end of the second TFT (T2) connects to a first reference signals (VGL), and a third end of the second TFT (T2) connects to the common electrode (COM).

4. The liquid crystal panel claimed in claim 3, wherein during the normal operations of the liquid crystal panel, the first reference signals (VGL) controls the second TFT (T2) to be disconnected, and the scanning lines and the common electrode (COM) are disconnected, when the power supply of the liquid crystal panel is abnormally interrupted, the first reference signals (VGL) controls the second TFT (T2) to be connected, and the scanning lines connect to the common electrode (COM) via the second TFT.

5. The liquid crystal panel claimed in claim 3, wherein the first switch unit further comprises a third TFT (T3), a first end of the third TFT (T3) connects to the other end of the scanning lines, a second end of the third TFT (T3) connects to the first reference signals (VGL), and a third end of the third TFT (T3) connects to the common electrode (COM).

6. The liquid crystal panel claimed in claim 5, wherein during the normal operations of the liquid crystal panel, the first reference signals (VGL) controls the second TFT (T2) and the third TFT (T3) to be disconnected, and the scanning lines and the common electrode (COM) are disconnected, when the power supply of the liquid crystal panel is abnormally interrupted, the first reference signals (VGL) controls the second TFT (T2) and the third TFT (T3) to be connected, and the scanning lines connects to the common electrode (COM) via the second TFT (T2) and the third TFT (T3).

7. The liquid crystal panel claimed in claim 5, wherein the second switch unit comprises the fourth TFT (T4) and the fifth TFT (T5), a first end of the fourth TFT (T4) connects to a first end of the fifth TFT (T5) and one end of the data line, a second end of the fourth TFT (T4) connects to second reference signals (VGH), a third end of the fourth TFT (T4) and a third end of the fifth TFT (T5) connects to the common electrode (COM), and a second end of the fifth TFT (T5) connects to the first reference signals (VGL).

8. The liquid crystal panel claimed in claim 7, wherein during the normal operations of the liquid crystal panel, the first reference signals (VGL) controls the fifth TFT (T5) to be disconnected, the second reference signals (VGH) controls the fourth TFT (T4) to be disconnected, and the data line and the common electrode (COM) are disconnected, when the power supply of the liquid crystal panel is abnormally interrupted, the first reference signals (VGL) controls the fifth TFT (T5) to be connected, and the data lines connect to the common electrode (COM) via the fifth TFT (T5).

9. The liquid crystal panel claimed in claim 8, wherein the first TFT (T1) and the fourth TFT (T4) are P-type TFTs, and the second TFT (T2), the third TFT (T3), and the fifth TFT (T5) are N-type TFTs.

10. A liquid crystal device (LCD) comprises the liquid crystal panel as claimed in claim 1.
